(19) United States
(12) Patent Application Publication
(10) Pub. No.: US 2011/0143955 A1
(43) Pub. Date: Jun. 16, 2011

(54) Protein Capture, Detection and Quantitation

(76) Inventor: Michael P. Weiner, Guilford, CT (US)

(21) Appl. No.: 12/902,379

(22) Filed: Oct. 12, 2010

Related U.S. Application Data
(60) Provisional application No. 61/250,532, filed on Oct. 11, 2009.

(51) Int. Cl. C40B 30/04; C40B 40/10

(52) U.S. Cl. 506/9; 506/18

(57) ABSTRACT

This invention is related to the area of the capture, detection and quantitation of proteins. In particular, it relates to making and using recombinant antibodies bound to oligonucleotides and using such complexes for analytic purposes. These techniques are designed to permit multiplexed detection and quantitation of very large numbers of proteins.

### CROSS-REFERENCE

This application claims the benefit of U.S. provisional Application No. 61/250,532, filed Oct. 11, 2009, the entire disclosure of which is incorporated herein by reference.

### TECHNICAL FIELD OF THE INVENTION

This invention is related to the area of the capture, detection and quantitation of proteins. In particular, it relates to making and using recombinant antibodies bound to oligonucleotides and using such complexes for analytic purposes.

### BACKGROUND OF THE INVENTION

Essential to the ambition of fully characterizing the human proteome are systematic and comprehensive collections of specific affinity reagents directed against all human proteins, including splice variants and modifications. Although a large number of affinity reagents are available commercially, their quality is often questionable and only a fraction of the proteome is covered. In order for more targets to be examined, there is a need for broad availability of panels of affinity reagents, including binders to proteins of unknown functions. In addition to the formidable task of assembling these reagents are the challenges of developing an inexpensive and facile means for using them.

There is a continuing need in the art to create affinity reagents for interrogating the proteome. There is a continuing need in the art for manipulable backbone structures for combining proteins and protein domains. There is a continuing need in the art for arrays for interrogating the proteome. There is a continuing need in the art for methods for quantitating proteins over a wide range of concentrations. There is a continuing need in the art for protein immobilization techniques in which the proteins retain biological activity. These and other needs are met as described below.

### SUMMARY OF THE INVENTION

According to one embodiment, a protein-nucleic acid complex is provided. The complex comprises a fusion protein and one or more nucleic acid molecules. The nucleic acid attachment to the fusion protein is optionally a covalent attachment or a non-covalent, high affinity attachment. Each nucleic acid molecule is optionally single-stranded, double-stranded or is comprised of a combination of single-stranded and double-stranded regions. The protein-nucleic acid complex is used in the detection and quantitation of a molecule that it is desirable to detect and measure, i.e., a “target molecule”.

According to another embodiment, one domain of the fusion protein of the protein-nucleic acid complex is an antibody.

According to yet another embodiment, one domain of the fusion protein of the protein-nucleic acid complex is the target molecule or a portion thereof.

According to yet another embodiment, one domain of the fusion protein of the protein-nucleic acid complex is designed to affix the complex to a suitable substratum.

According to yet another embodiment, one or more of the nucleic acid molecules of the protein-nucleic acid complex is amplified to permit the detection and quantitation of a target molecule. According to this embodiment amplification of the one or more nucleic acid molecule or molecules occurs only when one or more of the fusion proteins is bound to a target molecule.

According to yet another embodiment, one or more of the nucleic acid molecules of the protein-nucleic acid complex is designed to affix the complex to a suitable substratum.

According to yet another embodiment, the protein-nucleic acid complex is comprised of a fusion protein that comprises a first antibody, a nucleic acid and a tether which affixes the complex to a suitable substratum. A sample is contacted with the protein-nucleic acid complex such that if the sample contains a target molecule for which the first antibody has the ability to bind, the target molecule will become bound to the complex. A second protein-nucleic acid complex is then added which is comprised of a nucleic acid and a fusion protein containing a second antibody that binds to the target at a location different from the first antibody such that both the first antibody and the second antibody can bind simultaneously to the target molecule. A bridge oligonucleotide added to the sample hybridizes to a portion of the nucleic acids in both the first and second protein-nucleic acid complexes and portions of those nucleic acid complexes are then amplified in the presence of suitable primers to provide a detectable and quantifiable signal that is proportionate to the amount of target molecule in the sample. In a preferred form of this embodiment the tether is a nucleic acid such that the nucleic acid recognizes its complement which is attached to a substratum. In an alternative form of this embodiment the tether is a non-nucleic acid molecule that can bind with high affinity to a molecule on a suitable substratum, a non-limiting example of such binding molecules being biotin and streptavidin.

According to yet another embodiment, the protein-nucleic acid complex is comprised of two fusion proteins, each of which comprises an antibody and a nucleic acid-binding domain such that the two fusion proteins are joined by a nucleic acid. The antibodies in the fusion proteins are designed to bind to different regions of a target molecule. A sample is contacted with the protein-nucleic acid complex such that if the sample contains a molecule to which one or both of the antibodies bind, that molecule will become bound to the complex. The nucleic acid component of the complex is then partially digested such that the two fusion proteins will become spatially separated unless both antibodies remain associated by a molecule that is presumably the target molecule. Enzymes are then added to the mixture under circumstances such that nucleic acid molecules from complexes in which both antibodies are bound to a target molecule have a high probability of becoming re-ligated. Such re-ligated nucleic acids are then amplified in the presence of suitable primers to provide a detectable and quantifiable signal that is proportionate to the amount of target molecule in the sample.

According to yet another embodiment, two molecular complexes are provided. A first complex is comprised of a nucleic acid that is attached (covalently or non-covalently) to a “competitor” molecule that is known to bind to two antibodies that are also known to bind to a target molecule; said competitor molecule can alternatively be a protein, or a peptide or a non-protein molecule. A second molecular complex is comprised of two fusion proteins, each of which is comprised of an antibody and a nucleic acid-binding domain such that the two fusion proteins are joined by a nucleic acid. In one such version the second molecular complex is attached to a suitable substratum either through nucleic acid or protein contacts prior to exposure to a sample. In an alternative version the second molecular complex is exposed to a sample in solution and then captured onto a suitable substratum either through nucleic acid or protein contacts. In all such versions of this embodiment, the first molecular complex is mixed with the second molecular complex so as to form a larger complex in which the two antibodies of the second complex bind to the competitor molecule. The large complex is then exposed to a sample. If said sample contains the target molecule, said target molecule will displace some of the complexes containing competitor molecules. The displaced complexes are then isolated and part or all of the nucleic acid in the displaced complex is amplified and the amplified product measured, such product reflecting the amount of target molecule in the sample.

According to yet another embodiment, one molecular complex is provided containing two fusion proteins, each protein component containing an antibody that can bind either to a target or a competitor molecule and a nucleic acid-binding domain such that the antibodies are attached via a nucleic acid. In this embodiment, said antibody-containing complex is bound to a competitor molecule that is in turn attached to a suitable substratum. A sample is then added. If the sample contains target molecules, at least some of said target molecules will displace at least some of the competitor molecule from association with the antibody-containing complex and as a result antibody-containing complexes will be separated from the substratum. The nucleic acid moiety in the separated complexes is then amplified and the amplified product measured, such product being indicative of the amount of target molecule in the sample.

According to yet another embodiment, a first molecular complex is provided containing two fusion proteins, each protein component containing an antibody that can bind either to a target or a competitor molecule and a nucleic acid-binding domain such that the antibodies are attached via a nucleic acid. In this embodiment, said antibody-containing complex is bound to a competitor molecule that is in turn attached to a suitable substratum. A sample is then added. If the sample contains target molecules, at least some of said target molecules will displace at least some of the competitor molecule from association with the antibody-containing complex and as a result increasing numbers of competitor molecules not bound to antibody-containing complexes will remain on the substratum substratum. The unbound first molecule complex is removed and a second molecule complex, the same as the first except that the sequence of the nucleic acid is different, is exposed to the competitor molecules bound to the substratum. The nucleic acid sequence of the second molecular complex is amplified, the amount of amplified and the amplified product measured, such product being indicative of the amount of target molecule in the sample. In one version of the present embodiment, the competitor molecule contains an epitope that is not in common with the target molecule, such that one of the antibodies of the first molecular complex has affinity for a domain shared by the target and competitos molecules whereas the other antibody in the first molecular complex binds to a domain that is exclusive to the competitor molecule.

According to yet another embodiment, a molecular complex is provided containing two fusion proteins, each protein component containing a nucleic acid-binding domain and an antibody domain that can bind to a different epitope on a target molecule such that the fusion proteins are arrayed along the length of a nucleic acid. The free ends of the nucleic acid molecule are of a length such that they are unlikely to come into apposition to each other unless both antibodies are bound to the same target molecule. A ligation reaction is carried out to join the ends of the nucleic acids in complexes in which both antibodies are bound to a target molecule. The nucleic acid moiety in such bound complexes is then amplified and the amplified product measured, such product being indicative of the amount of target molecule in the sample.

In the foregoing embodiments the fusion proteins consist of an antibody and a protein (or protein epitope) that binds nucleic acids either through covalent or tight non-covalent interactions. Non-limiting examples of the former proteins (or protein moieties) are Tus, Rap, mutaEcoR1 and LacIs; non-limiting examples of the latter proteins (or protein moieties) are halo-tag, snap-tag, cutinase, DNA methylase and trwC.

As another variable in the foregoing embodiments in which competitor molecules are provided, in certain cases antibodies can be purposefully selected that bind more tightly to the target molecule than to the counterpart competitor molecule or, conversely, that bind more tightly to the competitor molecule than to the counterpart target molecule. Such purposeful differential affinities are used to modulate the amount of competitor molecule that is freed from its binding to antibody, which in turn influences the amount of nucleic acid amplification that occurs.

In the foregoing embodiments, the nucleic acid moieties in the protein-nucleic acid complexes are comprised of DNA. In other alternatives, the nucleic acid complexes are comprised of RNA, or a mixture of DNA and RNA. In yet another alternatives, the nucleic acid molecules may be comprised in whole or in part of non-natural components such as methyl phosphonates and/or phosphorothioates and the like. In these embodiments the nucleic acids may comprise a double-stranded portion and a single-stranded portion. The double-stranded portion optionally comprises a sequence that binds to the nucleic acid-binding moiety of the fusion protein, one non-limiting example being the Ter sequence which is bound by the Tus protein. The remaining portion of the nucleic acid sequence can alternatively be single-stranded or double-stranded and might, in one alternative, be a single-stranded portion comprising a tag sequence that uniquely corresponds to the binding polypeptide, or as the case might be, to the complex of which the nucleic acid is a part. In addition, in such cases in which single-stranded tag sequences are employed a bridging oligonucleotide is added to the mixture under conditions in which complementary nucleic acid single strands will form double strands. The bridging oligonucleotide comprises a first and a second portion. The first portion is complementary to the tag sequence of the first binding polypeptide and the second portion is complementary to the tag sequence of the second binding polypeptide. The first and the second portions of the bridging oligonucleotide are separated by 0 to 6 nucleotides. Ligase is added to the mixture; the ligase joins 5′ and 3′ ends of nicked double-stranded nucleic acid molecules. Ligated molecules comprising the first and second tag sequences and the ligation junction are amplified, forming an amplified analyte nucleic acid strand. An assay is performed to determine amount in the mixture of the analyte nucleic acid strand. The amount of the analyte nucleic acid molecule is related to the amount of the target molecule.

These and other embodiments which will be apparent to those of skill in the art upon reading the specification provide the art with tools and reagents for manipulating protein molecules with the sophisticated analytic and synthetic techniques of nucleic acids.

### BRIEF DESCRIPTION OF THE DRAWINGS

Table. 1. Examples of nucleic acid-binding proteins that can be used as the nucleic acid-binding portion of fusion proteins.

FIG. 1A. Ligation selection assay performed on solid phase. One antibody-nucleic acid complex is bound to a substratum. A sample is provided. If the sample contains a target molecule (“analyte” in the figure), that target molecule binds to the substratum-associated antibody. A second antibody-nucleic acid is added together with a bridge oligonucleotide and ligase. If the two different antibodies bind to the same target molecules, the bridge oligonucleotide spans the two nucleic acid molecules and the ligase will, ligate together the two free ends, forming a double-stranded region that is then amplified. The amount of amplified product is a measure of the amount of target molecule present.

FIG. 1B. Affinity proximity reaction. A complex is provided containing two antibodies that are bound to a nucleic acid molecule. Each of the two antibodies is bound to a different domain of a target molecule. A sample is added. If the sample contains the target molecule, both antibodies of the complex can simultaneously bind to the target molecule. A nuclease is added followed by addition of ligase. In those instances In which both antibodies of a complex remained attached to the target molecule, the cleaved nucleic acid can be re-ligated, whereas in instances in which both antibodies of a complex were not bound to the target molecule, the two moieties of the cleaved nucleic acid would be not be in proximity to each other so as to permit ligation to occur. Intact double stranded nucleic acids are then ligated and the amount of amplified product is a measure of the amount of target molecule present.

FIG. 2A. Competitive assay in solution. A complex is provided containing two antibodies, connected by a nucleic acid molecule, each of which binds to a different domain of a competitor molecule (the “antibody-competitor complex”). The said competitor molecule has an associated nucleic acid (the “competitor nucleic acid”). The said two antibodies are also both able to bind to a target molecule. A sample is added. If the sample contains a target molecule, that target molecule can bind to the antibody complex in the stead of the competitor molecule. The antibody complexes are removed from solution by addition of a solid support to which the complex will bind, in the instance illustrated via the interaction between biotin and streptavidin. The competitor nucleic acid molecules remaining in solution are then amplified and the amount of amplified product is a measure of the amount of target molecule present.

FIG. 2B. Competitive assay on solid phase. A substratum-bound complex is provided containing two antibodies, connected by a nucleic acid molecule, each of which binds to a different domain of a competitor molecule (the “antibody-competitor complex”). The said competitor molecule has an associated nucleic acid (the “competitor nucleic acid”). The said two antibodies are also both able to bind to a target molecule. A sample is added. If the sample contains a target molecule, that target molecule can bind to the antibody complex in the stead of the competitor molecule, thus releasing the competitor molecule into solution. The solutions are then separated from the substratum and the competitor nucleic acid molecules in solution are then amplified and the amount of amplified product is a measure of the amount of target molecule present.

FIG. 3A. Inverted Assay Type I. A substratum-bound competitor molecule is provided. Also provided are complexes containing two antibodies, connected by a nucleic acid molecule, each of which binds to a different domain of the competitor molecule. The two interact to form an “antibody-competitor complex”. The two antibodies can also bind simultaneously to a target molecule. A sample is added. If the sample contains a target molecule, the antibody-competitor complex can be dissociated and the antibodies attached to the nucleic acid can bind to the target molecule in solution. The target molecule-antibody-nucleic acid complexes are then removed from the substratum and the recovered nucleic acid is amplified. The amount of amplified product is a measure of the amount of target molecule present.

FIG. 3B. Inverted Assay Type II. A substratum-bound competitor molecule is provided. Also provided are complexes containing two antibodies, connected by a nucleic acid molecule, each of which binds to a different domain of the competitor molecule. In the example illustrated, one binding domain is also present on a target molecule, whereas the second domain is unique to the competitor molecule, in this case a domain of maltose binding protein (MBP). A sample is added. If the sample contains a target molecule, a portion of the antibodies will dissociate from the competitor molecules and bind to the target molecules, thus freeing the competitor molecules. After removal of antibody complexes, new antibody complexes are added which contain a nucleic acid with a different sequence (“Zip Code 2”). Primers are added for the amplification of the Zip Code 2 nucleic acid molecules that are present. The amount of amplified product is a measure of the amount of target molecule present.

FIG. 4. Single Chain Ligation. A molecular complex is provided containing two fusion proteins, each fusion protein contains a nucleic acid-binding domain and an antibody domain. The two antibodies in the complex can bind simultaneously to a target molecule. The nucleic acid has free ends that extend beyond the binding sites of the fusion proteins. If both antibodies are bound to a target molecule (“analyte”), the two free ends are brought into apposition to each other. A ligation reaction is carried out under conditions in which the nucleic acid ends in each bound complex are significantly more likely to be ligated than the nucleic acid ends of complexes not bound to target or to nucleic acid ends of two different complexes. Following ligation, the nucleic acid moiety in such bound complexes is then amplified and the amplified product measured, such product being a measure of the amount of target molecule in the sample.

### DETAILED DESCRIPTION OF THE INVENTION

The inventors have developed a web of interrelated methods and products centered on the use of antibody-nucleic acid complexes to detect and quantitate target molecules, including proteins, that can be targeted at more than one domain by a pair of antibodies. The methods are designed to be used variously in solution or in solid phase and are amenable to use in multiplexed arrays.

A number of proteins, or protein domains, can be used to make polymers that comprise subunits which are complexes of protein and nucleic acid. The nucleic acid forms the backbone structure of the polymer. The protein portions are fusion proteins (also called hybrid proteins or chimeric proteins) in which one of the fused portions is a protein that can bind nucleic acids. A non-limiting list of such nucleic acid-binding proteins is provided in Table 1. The portion of the fusion protein that is not a nucleic acid binding domain is a domain that binds to a target molecule. This latter binding domain can be comprised of any desired polypeptide that binds to a target molecule. In a preferable embodiment this latter binding moiety is the binding portion of an antibody; more preferably the latter binding moiety is a scFv molecule. However, in alternative embodiments, the binding moiety can be a non-antibody entity; as a non-limiting example, a receptor protein that targets a known ligand.

The nucleic acid molecules may be DNA or RNA, or a combination of DNA and RNA or he molecules may comprise nucleotide analogues which resist nuclease degradation, as well as analogues which stiffen the nucleic acid backbone. Locked nucleotide analogues can be used in this regard. See Semeonov and Nikiforov, Nucleic Acids Research 2002, vol. 30, e91. Ordering of the fusion proteins can be achieved for example using sequential ligation reactions. Alternatively, specific restriction endonuclease sticky ends on nucleic acid molecules can provide sufficient information to specify order of monomers in a dimer complex. Other means for achieving ordered ligation can be used.

The nucleic acid molecule in the complex can be completely double stranded or may comprise regions of double strandedness interspersed with regions of single strandedness or nicked double strands. The pattern of single and double stranded bonds may be used to obtain a desired three-dimensional conformation of the fusion proteins to optimize binding to the target molecule. Single stranded regions typically provide more flexibility to a polymer than double stranded regions. Double strands are typically more rigid. Nicks can be introduced into a double-stranded backboned polymer using enzymes such as nickases, for example. Alternatively, single stranded nicks may be made between two fragments using a single-stranded ligation reaction. One such reaction employs T4 RNA ligase. Another alternative employs restriction endonuclease digestion of hemimethylated or hemithiolated DNA to make single stranded nicks. Synthetic nucleotide analogues may be used in the single stranded addressing sequences. Synthetic nucleotide analogues may be used in order to introduce desired properties into a nucleic acid molecule, including without limitation the increased likelihood of binding to the binding domain of the fusion protein (see Table 1), resistance to nuclease digestion, increased polymer rigidity, labels, reactive moieties, and the like.

Complex dimers can be made by ligating two monomers (complexes of DNA and nucleic acids) to each other using a DNA ligase enzyme. Each monomer may comprise a non-covalent complex of a fusion protein or a covalent complex of a fusion protein (see Table 1) and, in each case a nucleic acid molecule (comprising a site to which each fusion protein is bound). In some cases, it may be desirable that some nucleic acid molecules contain no fusion protein bound to them. The nucleic acid molecules in the monomers may have 5′ and 3′ sticky ends. The 5′ and 3′ sticky ends of the nucleic acid molecules may be identical or distinct. Distinct ends may be used to facilitate the ordered assembly of monomers. Complexes may function in solution or they may themselves be tethered to a substratum. The substratum may be, for example, a bead, an array, a chromatography matrix. Use of a substratum permits the ready separation of enzymes and products. Any means known in the art for attaching a nucleic acid or a protein to a solid support may be used. These include covalent and non-covalent attachments; nucleic acid hybridization, biotin-streptavidin and chemical coupling are non-limiting examples.

Complexes and libraries of such complexes can be used inter alia to attach to a substratum, such as an oligonucleotide array. The library is a composition comprising a plurality of diverse protein-DNA complexes. Each complex comprises one or more fusion proteins that bind(s) to a nucleic acid and a nucleic acid molecule. The fusion protein may comprise, as a non-limiting example, a Tus protein and an scFv fragment, but other combinations are contemplated, as suggested by the non-limiting examples in Table 1. In certain embodiments, the nucleic acid binding polypeptide is fused to other types of polypeptides, particularly binding polypeptides, and more particularly antigen-binding polypeptides. A first portion of the nucleic acid molecule is double stranded and a second portion of the nucleic acid molecule is single stranded. The first portion comprises a protein binding sequence sequence (for binding to the fusion protein) and optionally a second portion comprises an addressing sequence (for hybridizing to a nucleic acid on a substratum). Typically an addressing sequence on a nucleic acid molecule is complexed with a fusion protein comprising a unique binding polypeptide, i.e., there is a correspondence (typically a 1:1 correspondence) between a binding polypeptide and an address.

Libraries of complexes may be packaged in a container as such, for example as a liquid or solid, frozen or lyophilized. The library may be a single composition or a divided composition. The library may be already attached to one or more substrata or not yet attached. The substrata may be provided together with or separately from the library. The substratum may have geographically located single stranded probes, each of which comprise a sequence of at least 6 nucleotides which is complementary to an addressing sequence in the nucleic acid molecules of the monomer complexes. Such a substratum is frequently referred to as an array or a chip. These are available commercially. Alternatively beads or nanoparticles can be used as substrata. Such substrata have a uniquely identifiable or detectable label. For example, each bead may be labeled with a unique barcode, dye, dye concentration, or radiolabel. Such substrata form a suspended array rather than a geographically located array. Alternatively the monomer complexes may be used for binding to moieties other than substrata, such as fluorescent labels. Such complexes may be used in a homogeneous phase reaction. In these situations, as in the case of a substratum, the complexes are attached to another moiety using hybridization of single strand addresses. As discussed elsewhere, “unique” as used here does not require a strict one-to-one relationship. Rather a correspondence or relationship between two elements is intended.

Addressing sequences that are present in the nucleic acid-binding protein complexes may be at least 6, at least 8, at least 12, at least 14, at least 16, at least 18, at least 20, at least 22, at least 24, at least 25, at least 26, at least 28, or at least 30 nucleotides in length. Specificity may depend on the complexity of mixtures of sequences and the conditions under which hybridization of single strands occurs. Similarly, the complements of the addressing sequences that are found, for example, on an oligonucleotide array, may be at least 6, at least 8, at least 12, at least 14, at least 16, at least 18, at least 20, at least 22, at least 24, at least 25, at least 26, at least 28, or at least 30 nucleotides in length.

In a geographically arrayed library of binding polypeptides or antigen-binding polypeptides, such as scFv fragments, each binding polypeptide is typically tethered to the array using non-covalent binding of a nucleic acid binding protein to a cognate nucleic acid sequence. Each binding polypeptide is fused to a nucleic acid binding protein, forming a fusion protein. Each cognate nucleic acid sequence is within a nucleic acid molecule comprising double and single stranded portions. The single stranded portions comprise an addressing sequence and the double stranded portions optionally comprise the cognate nucleic acid sequence. An addressing sequence can be present that is complementary to a single stranded probe which is attached to a substratum; thus the addressing sequence can hybridize to the probe, thereby accomplishing the arraying of a library of binding polypeptides. The single stranded probes may be attached to the substratum by means of non-covalent interactions (such as biotin-streptavidin interactions) or by means of covalent bonds (as made, for example, using photolithography).

Target molecules can be measured using two distinct target-binding polypeptides, such as scFv fragments. A first and a second binding polypeptide are mixed with a target molecule to be measured, forming a mixture. Each binding polypeptide is part of a fusion protein with a nucleic acid-binding protein, which in turn is bound to a DNA molecule which typically comprises a double-stranded portion and a single-stranded portion. The double-stranded portion comprises a cognate binding sequence, and the single stranded portion comprises a tag sequence which is unique to (or corresponds to) the binding polypeptide. In cetain embodiments a bridging oligonucleotide is added to the mixture under conditions in which complementary DNA single strands form double strands. In some embodiments the bridging oligonucleotide comprises a first and a second portion wherein the first portion is complementary to the tag sequence of the first binding polypeptide and the second portion is complementary to the tag sequence of the second binding polypeptide. The first and the second portion of the bridging oligonucleotide are separated by 0 to 6 nucleotides. DNA ligase is added to the mixture; the ligase joins 5′ and 3′ ends of nicked double-stranded DNA molecules. An assay is performed to determine amount in the mixture of an analyte DNA strand comprising both the tag sequence of the first antigen-binding polypeptide and the tag sequence of the second antigen-binding polypeptide. The amount of the analyte DNA molecule is related to the amount of the target antigen. If the first and the second portions of the bridging oligonucleotides are separated by 1 to 6 nucleotides they form a gap. The gap can optionally be filled in by addition of a DNA polymerase and deoxynucleotides to the mixture prior to adding the DNA ligase. The DNA polymerase fills in single-stranded gaps of less than 7 nucleotides in a double-stranded DNA molecule. The use of a gap and fill-in reaction are optional, but may improve the specificity of the analysis. If there is no gap, i.e., the first and second portions of the bridging oligonucleotides are separated by 0 nucleotides, then no fill-in reaction need be performed. In order to facilitate detection and quantitation of the analyte DNA molecule, it can be amplified using as non-limiting examples, a polymerase chain reaction, rolling circle reaction, and ligase chain reaction. Any means of detection of the analyte can be used. Another optional step is to use an exonuclease to remove non-ligated molecules after the ligation reaction. This typically reduces background noise in the detection reactions.

Arrayed libraries of diverse protein-DNA complexes can be made by mixing together a substratum comprising one or more single stranded probes and a library of diverse protein-DNA complexes. Each protein-DNA complex comprises a fusion protein and a nucleic acid molecule. The fusion protein comprises a nucleic acid binding protein and a binding polypeptide. A first portion of the nucleic acid molecule is double stranded and a second portion of the nucleic acid molecule is single stranded. The first portion comprises a nucleic acid binding sequence and the second portion comprises an addressing sequence. Each addressing sequence is complexed with a fusion protein comprising a unique or corresponding binding polypeptide. There is a correspondence between the addressing sequence and the binding polypeptide. The single-stranded probes each comprise a sequence of at least 6 nucleotides which is complementary to an addressing sequence in the nucleic acid molecules of the protein-DNA complexes. Upon mixing, the protein-DNA complexes bind to single stranded probes having complementary sequences by Watson-Crick hybridization. Binding polypeptides which may be used include scFv fragments, ligands, receptors, enzyme substrates, substrate analogues, enzymes, and enzyme inhibitors. Arrayed libraries can be arrayed on geographical arrays on substrata including silicon chips or glass slides, or suspended arrays on substrata, including beads or chromatography matrices.

Protein:nucleic acid interaction and application in the development of self-assembling protein arrays. The high-throughput deposition of recombinant proteins on chips, beads or biosensor devices is greatly facilitated by self-assembly. DNA-directed immobilization (DDI) via conjugation of proteins to an oligonucleotide is well suited for this purpose. DDI of proteins has been estimated to be 100-fold more economical in the use of purified protein material compared to direct spotting of proteins on substrata [Nedved 1994]. This advantage would become even more significant if lower protein concentrations and smaller spot sizes could be used. The current technology for DNA arrays is in the 40-μm range for spot sizes, but soft lithography techniques can create arrays of 40-nm dimensions. Such arrays can be interlaced with grids of 1- and 3-D DNA assemblies as described by Seeman [2003]. These advances in DNA arrays allow the precise positioning of arrays of protein clusters or even single protein molecules in a process of self assembly. DDI is at least as effective as current spotting methods and provides robust, high functional scFv arrays.

High throughput antibody discovery. The term proteomics has been applied to efforts to describe parallel processing systems that permit functional analysis of most or all proteins encoded by an organism. Currently the rate of proteomic analysis is not comparable to that which can be achieved by mRNA profiling approaches. However, the techniques disclosed here are designed to permit mRNA profiling approaches to be subverted for protein profiling.

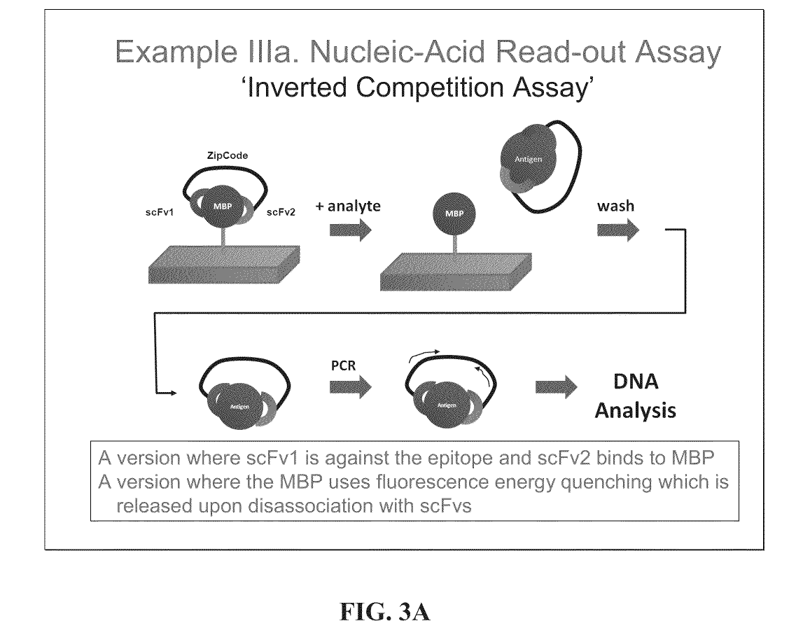

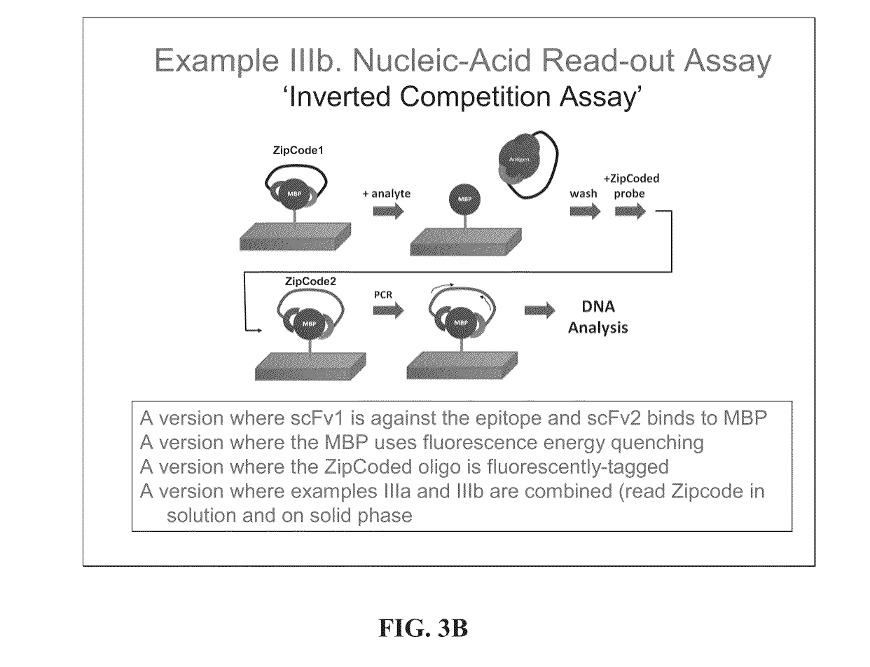

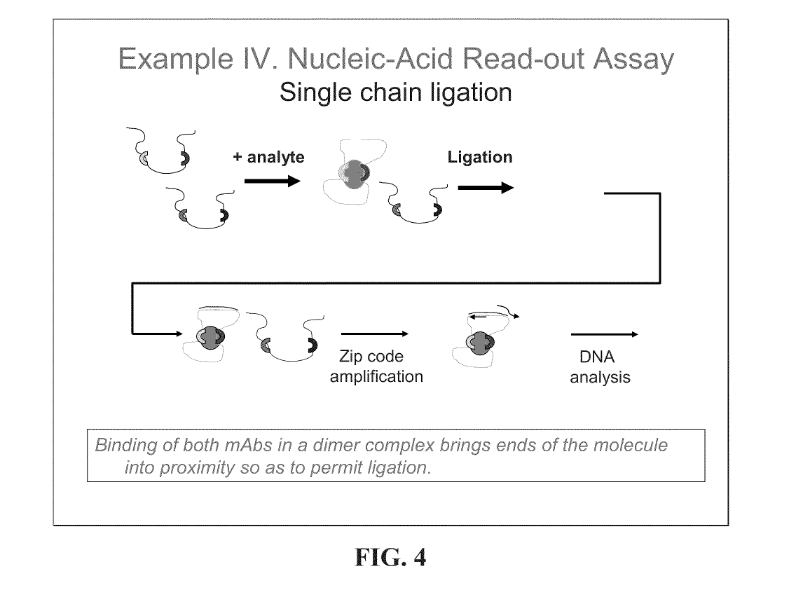

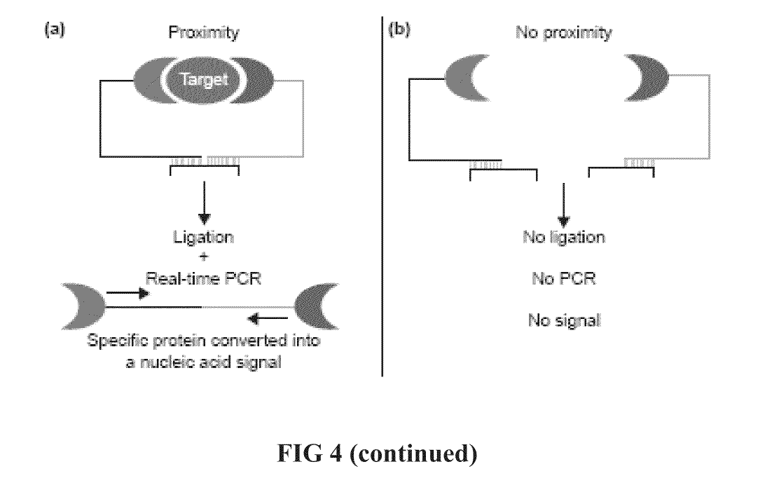

Antibodies, and particularly monoclonal antibodies (mAbs) are prototypic affinity reagents for identification and quantitation of proteins in a sample. One method used for generating mAbs of high quality is phage display (FIG. 3B, and Lee 2004; Sheets 1998). In this method a library of single chain, variable fragment (scFv) antibodies are displayed on the surface of M13 bacteriophage gpIII as genetic fusions to the gpIII protein and used in ‘biopanning’ procedures against an antigen of interest. Although phage display offers efficiencies and cost savings relative to hybridoma technology, the need for several biopanning, wash, plating, and ELISA steps in the current manifestation does not present a compelling approach for making tens of thousands of antibodies. An automated yeast two-hybrid approach for selecting scFv against target antigens could satisfy such needs [R. Buckholz, C. Simmons, J. Stuart, M. Weiner. Automation of Yeast Two-hybrid Screening. (1999) JMMB Communication 1:135-140].

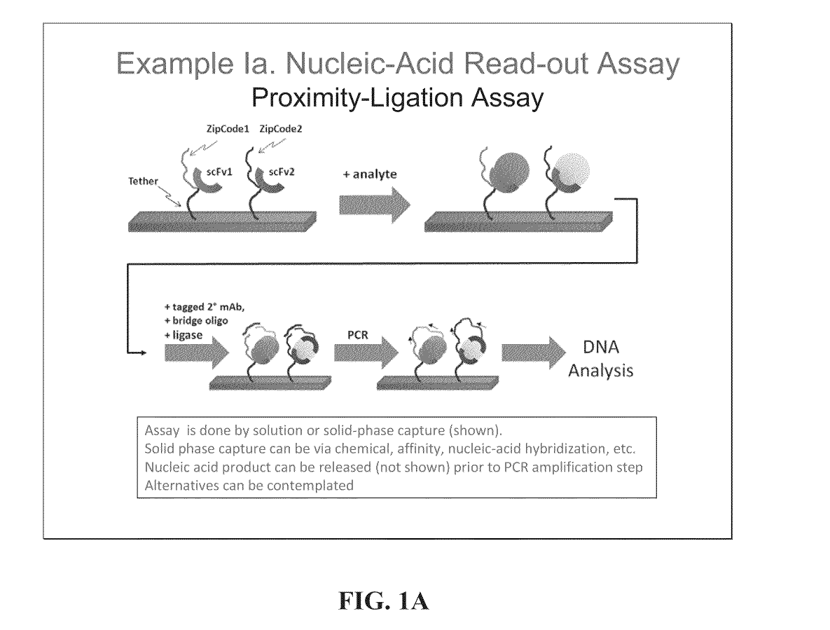

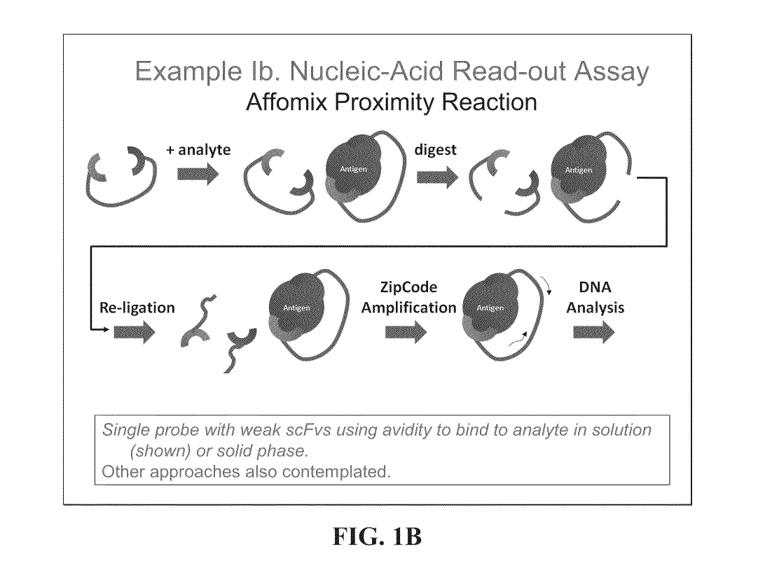

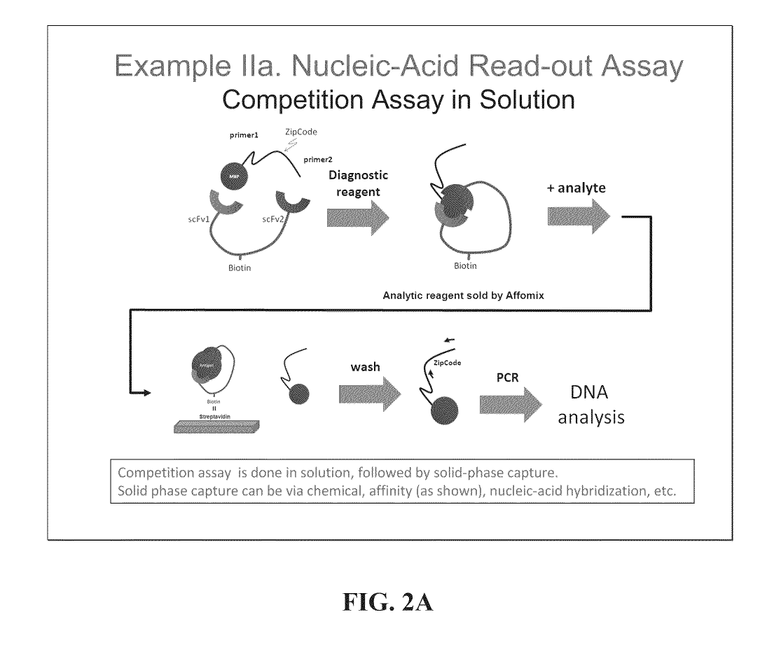

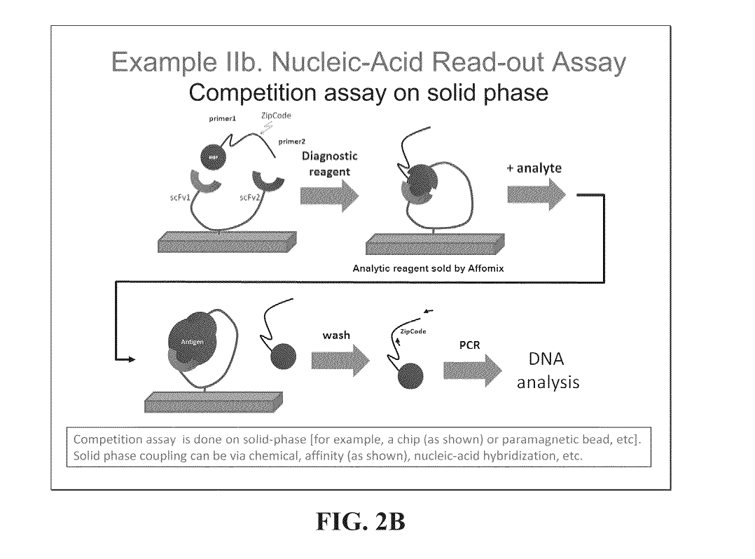

Proximity Ligation Assay. PLA (see FIG. 5) is a recently developed strategy for protein analysis in which antibody-based detection of a target protein in solution via a DNA ligation reaction of oligonucleotides linked to the antibodies results in the formation of an amplifiable DNA strand suitable for analysis [Dahl 2005, Fredriksson 2002, Gullberg 2003, Gullberg 2004, Gustafsdottir 2007, Jarvius 2007, Landegren 2004 Schallmeiner 2007, Söderberg 2007, Zhu 2006]. In PLA, pairs of proteins (in this case antibodies) containing oligonucleotide extensions are designed to bind pair-wise to a target protein and to form amplifiable tag sequences by ligation when brought in proximity (see FIG. 5). Sensitivity is achieved by the great increase in reactivity of ligatable ends on coincident target binding through increased relative concentration in combination with amplified DNA detection by real-time PCR, enabling the measurement of very few ligation products. PLA-like reactions can also be performed on a solid phase and, due to its proximity-dependent signal, it has displayed higher sensitivity than another DNA-based protein detection assay, immunoPCR [Adler 2005, Barletta 2006]. FIG. 1 provides an example of the use of PLA for quantitating target protein levels on solid phase. Typically, however, the nucleic acid entity is chemically attached to the antibody or other target-binding molecule. Such chemical attachment can interfere with binding of the antibody to its target molecule. Also chemical binding is expensive and impractical if it is desired to produce a library of antibody-nucleic acid reagents.

The high sensitivity of PLA allows 1-μl sample aliquots to be monitored, minimizing sample consumption and thus enabling analysis of samples available only in very small amounts that would not be measurable by traditional techniques. Also, 1,000-fold less antibody is used per assay compared to standard ELISAs, and because all assays perform favorably at similar reagent concentrations, new assays do not require extensive optimization. The precision of proximity ligation is currently at the level of real-time PCR detection, but improved quantitative detection strategies for nucleic acids may offer a further increase in precision [Söderberg 2006].

PLA is homogeneous, i.e., no washing steps are involved, and the procedure requires only the sequential additions to the incubation mixture of (1) the sample and (2) a ligation-PCR mixture. In addition, as more detection reactions are performed in parallel, the issue of antibody cross-reactivity becomes an increasing problem limiting scalability. PLA offers a possible solution to this problem if unique ligation junctions are used for each cognate proximity probe pair. Finally, by including a unique and amplifiable ZipCode sequence within the oligonucleotide attached to each different antibody, parallel analyses may be possible with PLA, allowing standard oligonucleotide capture arrays to be used for absolute or relative measurements of large sets of different proteins. Thus, the approach could be suitable for automation in high-throughput applications if there were a convenient and practical way to provide antibody-nucleic acid complexes

The availability of a convenient approach for producing large numbers of antibodies, each with their own unique zip codes, opens the possibility of multiplexing protein detection, providing unrivaled amounts of information. Additionally, the existence of several well tested and broadly used formats for measuring nucleic acids in multiplexed formats raises the possibility that antibody-nucleic acid complexes could be used for protein detection and quantitation on such formats. The present invention contemplates a number of different approaches in addition to PLA for carrying out such sensitive and multiplexed protein detection and quantitation. Different ones of these approaches could prove to be optima for use on different nucleic acid quantitation formats.

Molecular Inversion Probe (MIP) Technology [Hardenbol 2003, Moorhead 2006, Wang 2005]. One technology that is useful in conjunction with some of the protein detection technologies described herein is known as Molecular Inversion Probes (MIPs). MIPs have two specific homology sequences that leave a 1 bp gap when hybridized to an otherwise complementary sequence [Wang 2005]. MIPs also contain specific tag sequences that are ultimately bound to a DNA microarray. In addition to these elements that are specific to each probe, there are two PCR primers that are common to all probes. These primers face away from each other and therefore cannot facilitate amplification. After the probes are hybridized, the nucleotide is added to the tube. The gap is filled-in in the presence of the appropriate nucleotide. A unimolecular ligation event is then catalyzed. After eliminating the single stranded portions of the probes with exonucleases, PCRs using the common primers that now face each other is performed in the tube. In addition to signal amplification a fluorescent label is introduced by a PCR primer. The reaction is then hybridized onto a tag array. As many as 22,000 single nucleotide polymorphism (SNP) markers from an individual sample can be interrogated. The MIP technology has several features that convey advantages for this application over other methods using oligonucleotide arrays. In the assay, a high degree of specificity is achieved through a combination of the unique unimolecular probe design and selective enzymology which also allows the technology to be very highly multiplexed. The tag-based read-out array also conveys distinct advantages. By avoiding the use of genomic sequences to separate the signals on the array, cross hybridization levels among the different probes can be kept at a very low level, allowing signals to be quantitated with high precision.

Double stranded nucleic acid, especially DNA, behaves as a relatively rigid molecular rod. A nick, or single-stranded break in the backbone allows the molecule to rotate around the other strand, thereby introducing flexibility into the structure. The nick can be created by ligation of a single phosphate or by using a nickase enzyme. The introduction of flexibility or rotation in a nucleic acid backbone can be especially useful in trying to optimize the spatial relationship of fusion proteins attached to the nucleic acids in the complex.

T4 DNA ligase requires double stranded DNA with at least one 5′ phosphate adjacent to a 3′ hydroxyl group. Ligating a double stranded DNA having only a single phosphate and adjacent hydroxyl will create a nicked molecule, which confers flexibility to the structure. Conversely, the nucleic acid backbone can be further stiffened using modified nucleotides, for example, locked nucleotides (LNAs).

Nickase enzymes are similar to restriction enzymes except that they recognize an assymetric DNA sequence and nick one (but not both) strands of the DNA. Several of the nicking endonucleases are commercially available, including Nb.BbvCI, Nb.BsmI, Nb.BsrDI, Nb.BtsI, Nt.AlwI, Nt.BbvCI, Nt.BspQI, Nt.BstNBI, Nt.CviPII. New England Biolabs, Beverly, Mass.

The above disclosure generally describes the present invention. All references disclosed herein are expressly incorporated by reference. A more complete understanding can be obtained by reference to the following specific examples which are provided herein for purposes of illustration only, and are not intended to limit the scope of the invention.

### EXAMPLES

### Example IA

### Multiplexed Proximity Ligation Assay in Solid Phase Using a Nucleic Acid-Nucleic Acid-Binding Fusion Protein Complex

A plurality of fusion proteins are provided, each comprising two domains: (1) a moiety, preferably an antibody and more preferably a scFv moiety, that binds a target molecule and (2) a nucleic acid binding moiety. A nucleic acid is provided for each fusion protein which comprises a sequence that results in binding to the fusion protein and a zip code. Many nucleic acid binding polypeptides are known in the art; Table 1 provides a number of non-limiting examples, as well as the preferable chemical composition of the cognate nucleic acids for each. Cognate nucleic acid sequences that bind to each of these binding proteins are also known in the art. One non-limiting embodiment of this Example is illustrated in FIG. IA

In one embodiment, the fusion protein-nucleic acid complexes are bound to a substratum. Binding is variously achieved through nucleic acid hybridization or through the use of other binding partners, a non-limiting example being biotin and streptavidin: in one such embodiment biotin is attached to the substratum and streptavidin is an additional part of the fusion protein complex; in an alternative embodiment, streptavidin is attached to the substratum and biotin is an additional part of the fusion protein complex. In an embodiment in which the fusion protein is attached to the substratum via nucleic acid hybridization, a single nucleic acid is used comprising (i) a single-stranded sequence that hybridizes to a single stranded nucleic acid carrying a complementary sequence that is affixed to the substratum, (ii) a single-stranded or double stranded region comprising a sequence that binds to the fusion protein and (iii) a single stranded sequence that serves as a zip code (see FIG. IA). In an alternative embodiment, the binding sequence for the substratum and the zip code are on separate nucleic acid molecules.

A plurality of antibody fusion protein-nucleic acid complexes are affixed to the substratum such that each complex recognizes a known target molecule, the antibody in each complex being selected for its ability to bind to that target molecule. In this embodiment the number of different antibody complexes affixed to the substratum is within the range of ten and one hundred thousand, preferably within the range of one hundred and ten thousand. Non-limiting examples of substrata in this embodiment are chips, beads and slides.

A sample is added and after appropriate time of incubation under appropriate conditions for binding of target molecules the antibodies attached to the substratum, unbound sample is removed and a series of soluble antibody-containing fusion protein-nucleic acid complexes are added. Each of such soluble antibody-containing complexes is associated (via a nucleic acid binding protein that is a fusion protein partner) with a nucleic acid carrying a unique zip code. It is further the case that each antibody of the soluble complex is known to bind to a target molecule at a site different from that site to which a substrate-bound target antibody binds, so that zip codes are brought into proximity and are amenable to ligation. Once ligated, the nucleic acid is amplified and measurement of that amplified nucleic acid serves as a measure of the amount of target protein. Each antibody pair contains a unique pair of zip codes such that the amplified nucleic acids for each pair have a different sequence and are thus distinguished one form the other. This embodiment is illustrated in FIG. IA.

In an alternative embodiment, the sample is introduced to the first antibody-containing complexes in solution under appropriate times and conditions to allow binding of target molecules in the samples to their cognate antibodies. The mixture is then introduced to a substratum to which the first antibody-containing complexes bind (via hybridization, biotin-streptavidin interaction or the like, as described above). Material not bound to the substratum is removed and the second antibody complexes are added and ligation and amplification are carried out, with the resultant amplified nucleic acids serving as a measure of the amount of different target molecules in the sample.

### Example IB

### Affinity Proximity Reaction

In this Example a plurality of antibody-containing complexes are provided, each comprising two fusion proteins connected by a nucleic acid. Each fusion protein contains: (1) a moiety, preferably an antibody and more preferably a scFv moiety, that binds a target molecule and (2) a nucleic acid binding moiety. The two fusion proteins in a single complex are able to bind to different epitopes of the same target molecule at the same time. A nucleic acid is provided that binds to the nucleic acid binding domains of the two fusion proteins, producing an antibody-nucleic acid-antibody complex, as illustrated in FIG. IB. The nucleic acid binding domain of each fusion protein in the complex is selected from among proteins known to bind covalently or non-covalently but tightly to a nucleic acid sequence known in the art. Table 1 contains a non-limiting list of such proteins and the types of nucleic acids to which they each preferably bind.

A sample is added. After an appropriate period of time under appropriate conditions to allow a target molecule to bind to its cognate antibodies in a complex, the complexes are incubated under conditions that results in a single cleavage of the nucleic acid components of the complex. Methods for achieving this are well known in the art. As one non-limiting example by which this is achieved, every nucleic acid used in the complexes has a single restriction enzyme cleavage site. Following cleavage of the nucleic acids, complexes that are not associated with a target molecule split in two and the two moieties become spatially separated, whereas the two moieties of complexes bound to a target molecule are kept spatially close to each other. A ligase is added to re-ligate the nucleic acid moiety of the complexes bound to a target molecule (see FIG. 1b). Such re-ligated nucleic acids are then amplified in the presence of suitable primers to provide a detectable and quantifiable signal that is proportionate to the amount of target molecule in the sample.

In various embodiments of this invention, there is a plurality of such complexes, each with a different nucleic acid sequence such that the sequence of the amplified nucleic acids indicates which target molecule has been detected and the quantity of each amplified nucleic acid sequence is an indicator of the quantity of each target molecule present in the sample.

In one embodiment of this invention the detection and quantitation is detected in solution (e.g., FIG. 1A). In another embodiment the complexes are attached to a substratum in any of the ways described above.

In a further embodiment of this invention the two antibodies in each complex are selected as relatively weak binders so that “true” target molecules, which bind to both antibodies in the complex will be distinguishable from “non-specific” binding molecules that bind only to one of the two antibodies because the former molecules will bind significantly more tightly than the latter due to avidity effects.

Other versions of this reactiuon are contemplated, including, but not limited to:

A version where scFv1 is against the epitope and scFv2 binds to MBP

A version where the MBP uses fluorescence energy quenching

A version where the ZipCoded oligo is fluorescently-tagged

A version where several of the previous examples (for example, IIIa and IIIb) are combined (i.e., read the Zipcode in solution and on a solid phase)

### Example IIA

### Competition Assay in Solution

In this Example a plurality of target molecule binder-containing complexes are provided, each comprising two target molecule binders that can bind simultaneously to a target molecule but which, are initially bound to a non-target molecule that nevertheless binds to both target molecule binders (a “competitor molecule”). The target molecule binders in this complex that are bound to the competitor molecule are part of two fusion proteins connected by a nucleic acid. Each fusion protein contains: (1) a target binder moiety that is preferably an antibody and more preferably a scFv moiety and (2) a nucleic acid binding moiety. The two fusion proteins in a single complex are able to bind at the same time to different epitopes of either the cognate target molecule or the cognate competitor molecule.

A nucleic acid is provided that binds to the nucleic acid binding domains of the two fusion proteins, producing a complex as illustrated in FIG. IIA. This complex is hereinafter referred to in one embodiment of this invention as the “antibody-competitor complex”.

The nucleic acid binding domain of each fusion protein in the antibody-competitor complex is selected from among proteins known to bind covalently or non-covalently but tightly to a nucleic acid sequence known in the art. Table 1 contains a non-limiting list of such proteins and the types of nucleic acids to which they each preferably bind.

Also in this embodiment, the said competitor molecule has an associated single stranded nucleic acid which acts as a zip code (FIG. IIA). A sample is added. If the sample contains a target molecule, that target molecule can bind to the antibody complex in the stead of the competitor molecule. Thus the antibody-competitor complex becomes disrupted and an “antibody-target molecule complex” is formed, and the competitor molecule is freed into solution. The antibody-target molecule complexes are removed from solution by addition of a solid support to which the complexes bind, in the instance illustrated via the interaction between biotin and streptavidin, although in other embodiments other binding pairs, including complementary nucleic acids are utilized to cause adherence of the antibody-target molecule complexes to the substratum. The competitor nucleic acid molecules remaining in solution are then amplified and the amount of amplified product is a measure of the amount of target molecule present.

In yet another embodiment of this Example, the nucleic acid attached to the competitor molecule contains not only a zip code but also a single strand sequence that will hybridize to a complementary nucleic acid on the substratum and the antibody-target molecule complexes remain in solution and are washed away before amplification of the zip codes on the competitor molecules. Alternatively, other non-covalent binding pairs are used to adhere the competitor to a substratum or the competitor can be adhered chemically.

A number of alternatives are contemplated for construction of the competitor molecule. As one non-limiting example, the competitor molecule is comprised of a maltose binding protein, or other “backbone protein” to which epitopes of the target molecule are attached, along with a polypeptide that binds nucleic acid, e.g., one among the list in Table 1, as non-limiting examples. In one embodiment of the foregoing alternative the target molecule is a protein and the competitor molecule is a recombinant fusion protein.

### Example IIB

### Competition Assay on Solid Phase

This Example IIB is similar to Example IIA with the exception that the antibody-competitor complex, or a plurality thereof, is/are bound to a substratum prior to addition of the sample. The substratum is, as non-limiting examples, a chip, a slide or a paramagnetic bead. In this embodiment, target molecules displace competitor molecules, which are free in solution and the antibody-target molecule complexes remain bound to the sdubstratum. The solution is then collected and the zip codes on the competitor nucleic acid molecules in solution are then amplified and the amount of amplified product is a measure of the amount of target molecule present.

### Example IIIA

### Inverted Competition Assay, Type I

A plurality of substratum-bound competitor molecules are provided. Such competitor molecules each share two epitopes in common with a target molecule. As a non-limiting example shown in FIG. IIIA, the competitor molecule is a fusion protein comprising maltose binding protein and two epitopes of the target molecule. The target molecule, in turn, is a protein having such two epitopes against which antibodies have been obtained. The cognate two antibodies are each components of a fusion protein that also comprises a nucleic acid binding polypeptide (see, e.g., Table 1 for non-limiting examples). The two antibody-containing fusion proteins are joined by a nucleic acid that has a unique zip code.

A sample is added. If the sample contains a target molecule, the antibody-competitor complex is dissociated and the displaced antibody-containing complex attaches to the nucleic acid bind to the target molecule in solution. The target molecule-antibody-nucleic acid complexes are then collected and the zip codes of the complexes are amplified. The amount of each amplified product is a measure of the amount of corresponding target molecule present.

In one embodiment of this Example the relative affinities of the antibodies for a target molecule and the corresponding competitor molecule are modulated and selected so that the antibodies used bind more tightly to the target molecule than to the competitor molecule when the target molecule is of low abundance, whereas for higher abundance target molecules, the antibodies used bind less tightly to the target molecule than to the competitor molecule. Predetermined binding curves are optionally used to determine concentration of each target molecule based upon concentration of each corresponding amplified zip code. In this way the quantities of both high abundance and low abundance proteins can be more accurately measured in the same multiplexed array.

As a distinct embodiment of this example, one antibody in the complex has as its cognate antigen maltose binding protein and thus only one of the two antibodies in the complex binds to the target molecule. Under such circumstances, a relatively large concentration of target molecule is needed to displace complexes from the competitor molecule. Such embodiments are useful for measuring high abundance proteins when they are being multiplexed with lower abundance proteins.

As another non-limiting example, FLUORESCENCE QUENCHING [FQ] can be used for detection. In the method of FQ, the bringing of the moieties near each other causes a quenching of the signal, which can be measured using the appropriate detector.

### Example IIIB

### Inverted Competition Assay, Type II

This Example (see FIG. IIIB) is initially carried out by a similar procedure as described in Example IIIA. However, following displacement of the original antibody complexes from the competitor molecule upon addition of sample, the displaced complexes are discarded and a second complex containing a pair of fusion proteins, each with an antibody that binds an epitope of the target protein, as well as a unique zip code (a “second zip code set”), is contacted with the substratum. Competitor molecules that had their antibody complexes displaced by the addition of sample are now free to bind the second complex. After removing unbound antibody complexes the second zip code sets are amplified. The amount of amplified product is a measure of the amount of target molecule present.

Other methods can be applied, including the versions mentioned in the previous examples: A version where scFv1 is against the epitope and scFv2 binds to MBP

A version where the MBP uses fluorescence energy quenching

A version where the ZipCoded oligo is fluorescently-tagged

A version where examples IIIa and IIIb are combined (read Zipcode in solution and on solid phase

### Example IV

### Single Chain Ligation

A binding complex is provided containing two fusion proteins, each fusion protein containing a nucleic acid-binding domain and an target binder, preferably an antibody domain and more preferably an scFv. The nucleic acid binding proteins and their cognate nucleic acids are as described in prior Examples. The two antibodies in the complex bind simultaneously to a target molecule. The nucleic acid has free ends that extend beyond the binding sites of the fusion proteins.

A sample is added. As illustrated in FIG. IV, if a target binds both antibodies in the binding complex, it brings the free ends of the nucleic acid into closer proximity to each other. The complexes are then submitted to conditions that allow ligation to occur. Nucleic acids in complexes containing target molecules are ligated at a higher frequency than nucleic acids in complexes lacking target molecules. Following ligation, ligated nucleic acids are amplified and the amplified product measured, such product being a measure of the amount of target molecule in the sample.

### Example V

It is also contemplated that several of the previous examples may be used in combination such that the read-out can be used for multiple samples simultaneously.

TABLE 1

| Tag | Substrate/ligand | Affinity |
|---|---|---|
| Halo-tag | haloalkane* | covalent |
| Snap-tag | benzylguanine* | covalent |
| Cutinase | phosphonate | covalent |
| DNA methylase | dU or 5FdC* | covalent |
| trwC | phosphothioate* | covalent |
| Streptavidin | biotin | 10⁻¹⁴ |
| mutEcoRI | DNA | 10⁻¹³ |
| Tus | DNA | 10⁻¹³ |
| Rap | DNA | 10⁻¹³ |
| LacI^{s} | DNA | 10⁻¹³ |

Multiple possible approaches can be used, alone or combined.

### REFERENCES

The disclosure of each reference cited is expressly incorporated herein.
Adler M. Immuno-PCR as a clinical laboratory tool. Adv Clin Chem. 2005; 39:239-92.
Barletta J. Applications of real-time immuno-polymerase chain reaction (rt-IPCR) for the rapid diagnoses of viral antigens and pathologic proteins. Mol Aspects Med. 2006; 27:224-53.
Bartel, P. L., Chien, C., Steprnglanz, R. and Fields, S. (1993) In Hartley, D. A. (ed.), Cellular interaction in development: a practical approach. IRL Press, Oxford, pp. 153-179.
Bayer, E. A., H. Ben-Hur, Y. Hiller, and M. Wilchek. Post-secretory modifications of streptavidin. Biochem. J. 1989; 259:369-376.
Bendixen C, Gangloff S, Rothstein R. A yeast mating-selection scheme for detection of protein-protein interactions. Nucleic Acids Res. 1994; 22:1778-9.
Buckholz R G, Simmons C A, Stuart J M, Weiner M P. Automation of yeast two-hybrid screening. Mol Microbiol Biotechnol. 1999; 1:135-40.
Dahl F, Gullberg M, Stenberg J, Landegren U, Nilsson M. Multiplex amplification enabled by selective circularization of large sets of genomic DNA fragments. Nucleic Acids Res. 2005; 33: e71.
Duggan U, Hill T M, Wu S, Garrison K, Zhang X, Gottlieb P A. Using modified nucleotides to map the DNA determinants of the Tus:TerB complex, the protein-DNA interaction associated with termination of replication in Escherichia coli. J Biol. Chem. 1995; 270:28049-54.
Duggin I G, Andersen P A, Smith M T, Wilce J A, King G F, Wake R G. Site-directed mutants of RTP of Bacillus subtilis and the mechanism of replication fork arrest. J Mol. Biol. 1999; 286:1325-35.
Fan, Jian-Bing, M. S. Chee & K. L. Gunderson. Highly parallel genomic assays. Nature Reviews Genetics 2006; 7:632-644.
Figeys D. Adapting arrays and lab-on-a-chip technology for proteomics. Proteomics. 2002; 2:373-82.
Finley R L Jr, Brent R. Interaction mating reveals binary and ternary connections between Drosophila cell cycle regulators. Proc Natl Acad Sci USA. 1994; 91:12980-4.
Fredriksson S, Gullberg M, Jarvius J, Olsson C, Pietras K, Gustafsdottir S M, Ostman A, Landegren U. Protein detection using proximity-dependent DNA ligation assays. Nat. Biotechnol. 2002; 20:473-7.
Fromont-Racine M, Rain J C, Legrain P. Toward a functional analysis of the yeast genome through exhaustive two-hybrid screens. Nat. Genet. 1997; 16:277-82.
Gao X, Gulari E, Zhou X. In situ synthesis of oligonucleotide microarrays. Biopolymers. 2004; 73:579-96.
Giot, L., Bader, J. S., Brouwer, C., Chaudhuri, A., Kuang, B., Li, Y., Hao, Y. L., Ooi, C. E., Godwin, B., Vitols, E., Vijayadamodar, G., Pochart, P., Machineni, H., Welsh, M., Kong, Y., Zerhusen, B., Malcolm, R., Varrone, Z., Collis, A., Minto, M., Burgess, S., McDaniel, L., Stimpson, E., Spriggs, F., Williams, J., Neurath, K., Ioime, N., Agee, M., Voss, E., Furtak, K., Renzulli, R., Aanensen, N., Carrolla, S., Bickelhaupt, E., Lazovatsky, Y., DaSilva, A., Zhong, J., Stanyon, C. A., Finley, R. L., Jr, White, K. P., Braverman, M., Jarvie, T., Gold, S., Leach, M., Knight, J., Shimkets, R. A., McKenna, M. P., Chant, J., and Rothberg, J. M. A protein interaction map of Drosophila melanogaster. Science. 2003; 302:1727-1736.
Gullberg M, Fredriksson S, Taussig M, Jarvius J, Gustafsdottir S, Landegren U. A sense of closeness: protein detection by proximity ligation. Curr Opin Biotechnol. 2003; 14:82-6.
Gullberg M, Gustafsdottir S M, Schallmeiner E, Jarvius J, Bjarnegard M, Betsholtz C, Landegren U, Fredriksson S. Cytokine detection by antibody-based proximity ligation. Proc Natl Acad Sci USA. 2004; 101:8420-4.
Gullberg M, Gustafsdottir S M, Schallmeiner E, Jarvius J, Bjarnegard M, Betsholtz C, Landegren U, Fredriksson S. Cytokine detection by antibody-based proximity ligation. Proc
Natl Acad Sci USA. 2004; 101:8420-4.
Gustafsdottir S M, Schallmeiner E, Fredriksson S, Gullberg M, Söderberg O, Jarvius M, Jarvius J, Howell M, Landegren U. Proximity ligation assays for sensitive and specific protein analyses. Anal Biochem. 2005; 345:2-9.
Gustafsdottir S M, Schlingemann J, Rada-Iglesias A, Schallmeiner E, Kamali-Moghaddam M, Wadelius C, Landegren U. In vitro analysis of DNA-protein interactions by proximity ligation. Proc Natl Acad Sci USA. 2007; 104:3067-72.
Gustafsdottir, S. M., A. Nordengrahn, S. Fredriksson, P. Wallgren, E. Rivera, E. Schallmeiner, M. Merza, and U. Landegren. Detection of individual microbial pathogens by proximity ligation. Clin. Chem. 2006; 52:1152-1160.
Gustafsdottir, S. M., J. Schlingemann, A. Rada-Iglesias, E. Schallmeiner, M. Kamali-Moghaddam, C. Wadelius, and U. Landegren. In vitro analysis of DNA-protein interactions by proximity ligation. Proc. Natl. Acad. Sci. USA. 2007; 104:3067-3072.
Gutmann O, Kuehlewein R, Reinbold S, Niekrawietz R, Steinert C P, de Heij B, Lab Chip. 2005; 5:675-81.
Hardenbol P, Ban& J, Jain M, Nilsson M, Namsaraev E A, Karlin-Neumann G A, Fakhrai-Rad H, Ronaghi M, Willis T D, Landegren U, Davis R W. Multiplexed genotyping with sequence-tagged molecular inversion probes. Nat. Biotechnol. 2003; 21:673-8.
Hardenbol P, Yu F, Belmont J, Mackenzie J, Bruckner C, Brundage T, Boudreau A, Chow S, Eberle J, Erbilgin A, Falkowski M, Fitzgerald R, Ghose S, Iartchouk 0, Jain M, Karlin-Neumann G, Lu X, Miao X, Moore B, Moorhead M, Namsaraev E, Pasternak S, Prakash E, Tran K, Wang Z, Jones H B, Davis R W, Willis T D, Gibbs R A. Highly multiplexed molecular inversion probe genotyping: over 10,000 targeted SNPs genotyped in a single tube assay. Genome Res. 2005; 15:269-75.
Jarvius M, Paulsson J, Weibrecht I, Leuchowius K J, Andersson A C, Wahlby C, Gullberg M, Botling J, Sjöblom T, Markova B, Ostman A, Landegren U, Söderberg O. In situ detection of phosphorylated PDGF receptor beta using a generalized proximity ligation method. Mol Cell Proteomics. 2007; 6:1500-9.
Kamada K, Horiuchi T, Ohsumi K, Shimamoto N & Morikawa K. Structure of a replication-terminator protein complexed with DNA. Nature, 1996; 383, 598-603.
Landegren U, Schallmeiner E, Nilsson M, Fredriksson S, Banér J, Gullberg M, Jarvius J, Gustafsdottir S, Dahl F, Söderberg O, Ericsson O, Stenberg J. Molecular tools for a molecular medicine: analyzing genes, transcripts and proteins using padlock and proximity probes. J Mol. Recognit. 2004; 17:194-7.
Lee C V, Liang W C, Dennis M S, Eigenbrot C, Sidhu S S, Fuh G. High-affinity human antibodies from phage-displayed synthetic Fab libraries with a single framework scaffold. J Mol. Biol. 2004; 340:1073-93.
Li, S., Armstrong, C. M., Bertin, N., Ge, H., Milstein, S., Boxem, M., Vidalain, P. 0., Han, J. D., Chesneau, A., Hao, T., Goldberg, D. S., Li, N., Martinez, M., Rual, J. F., Lamesch, P., Xu, L., Tewari, M., Wong, S. L., Zhang, L. V., Berriz, G. F., Jacotot, L., Vaglio, P., Reboul, J., Hirozane-Kishikawa, T., Li, Q., Gabel, H. W., Elewa, A., Baumgartner, B., Rose, D. J., Yu, H., Bosak, S., Sequerra, R., Fraser, A., Mango, S. E., Saxton, W. M., Strome, S., Van Den Heuvel, S., Piano, F., Vandenhaute, J., Sardet, C., Gerstein, M., Doucette-Stamm, L., Gunsalus, K. C., Harper, J. W., Cusick, M. E., Roth, F. P., Hill, D. E., and Vidal, M. A map of the interactome network of the metazoan C. elegans. Science 2004; 303:540-543.
Lindskog M, Rockberg J, Uhlen M, Sterky F. (2005) Selection of protein epitopes for antibody production. Biotechniques. 2005; 38:723-7.
Link, D. R., S. L. Anna, D. A. Weitz, and H. A. Stone, 2004, Geometrically Mediated Breakup of props in Microfluidic Devices. Phys Rev Lett, 92: 054503.
Maarten A. Jongsma and Ralph H. G. M. Litjens. Self-assembling protein arrays on DNA chips by auto-labeling fusion proteins with a single DNA address. Proteomics 2006; 6:2650-2655.
MacBeath G, Schreiber S L. Printing proteins as microarrays for high-throughput function determination. Science. 2000; 289:1760-3.
Mizuta R, Mizuta M, Kitamura D. Atomic force microscopy analysis of rolling circle amplification of plasmid DNA. Arch Histol Cytol. 2003; 66:175-81.
Moorhead M, Hardenbol P, Siddiqui F, Falkowski M, Bruckner C, Ireland J, Jones H B, Jain M, Willis T D, Faham M. Optimal genotype determination in highly multiplexed SNP data. Eur J Hum Genet. 2006; 14:207-15. Erratum in: Eur J Hum Genet. 2006; 14:976.
Mulcair M D, Schaeffer P M, Oakley A J, Cross H F, Neylon C, Hill T M, Dixon N E. A molecular mousetrap determines polarity of termination of DNA replication in E. coli. Cell. 2006; 125:1309-19.
Nedved M L, Gottlieb P A, Moe G R. CD and DNA binding studies of a proline repeat-containing segment of the replication arrest protein Tus. Nucleic Acids Res. 1994; 22:5024-30.
Neylon C, Brown S E, Kralicek A V, Miles C S, Love C A, Dixon N E. Interaction of the Escherichia coli replication terminator protein (Tus) with DNA: a model derived from DNA-binding studies of mutant proteins by surface plasmon resonance. Biochemistry. 2000; 39:11989-99.
Niemeyer C M, Sano T, Smith C L, Cantor C R. Oligonucleotide-directed self-assembly of proteins: semisynthetic DNA—streptavidin hybrid molecules as connectors for the generation of macroscopic arrays and the construction of supramolecular bioconjugates. Nucleic Acids Res. 1994; 22:5530-9.
Niemeyer, C. M., M. Adler, B. Pignataro, S. Lenhert, S. Gao, L. Chi, H. Fuchs, and D. Blohm. Self-assembly of DNA-streptavidin nanostructures and their use as reagents in immuno-PCR. Nucleic Acids Res. 1999; 27:4553-4561.
Schallmeiner, E., E. Oksanen, O. Ericsson, L. Spangberg, S. Eriksson, U. H. Stenman, K. Pettersson, and U. Landegren. Sensitive protein detection via triple-binder proximity ligation assays. Nat. Methods 2007; 4:135-137.
Seeman N C. DNA in a material world. Nature. 2003; 421:427-31.
Sheets, M. D., Amersdorfer, P., Finnern, R., Sargent, P., Lindqvist, E., Schier, R., Hemingsen, G., Wong, C., Gerhart, J. C. and Marks, J. D. Efficient construction of a large nonimmune phage antibody library: the production of high-affinity human single-chain antibodies to protein antigens. Proc. Natl. Acad. Sci. USA, 1998; 95:6157-6162.
Skokotas A, Hiasa H, Marians K J, O'Donnell L, Hill T M. Mutations in the Escherichia coli Tus protein define a domain positioned close to the DNA in the Tus:Ter complex. J Biol. Chem. 1995; 270:30941-8.
Skokotas A, Wrobleski M, Hill T M. Isolation and characterization of mutants of Tus, the replication arrest protein of Escherichia coli. J Biol. Chem. 1994; 269:20446-55.
Slentz-Kesler K, Moore J T, Lombard M, Zhang J, Hollingsworth R, Weiner M P. Identification of the human Mnk2 gene (MKNK2) through protein interaction with estrogen receptor beta. Genomics. 2000; 69:63-71.
Söderberg O, Gullberg M, Jarvius M, Ridderstråle K, Leuchowius K J, Jarvius J, Wester K, Hydbring P, Bahram F, Larsson L G, Landegren U. Direct observation of individual endogenous protein complexes in situ by proximity ligation. Nat. Methods. 2006; 3:995-1000.
Söderberg O, Leuchowius K J, Kamali-Moghaddam M, Jarvius M, Gustafsdottir S, Schallmeiner E, Gullberg M, Jarvius J, Landegren U. Proximity ligation: a specific and versatile tool for the proteomic era. Genet Eng (N Y). 2007; 28:85-93.
Stoevesandt O., and M. J. Taussig. Affinity reagent resources for human proteome detection: Initiatives and perspectives. Proteomics 2007; 7:2738-2750
Taylor J D, Briley D, Nguyen Q, Long K, Iannone M A, Li M S, Ye F, Afshari A, Lai E, Wagner M, Chen J, Weiner M P. Flow cytometric platform for high-throughput single nucleotide polymorphism analysis. Biotechniques. 2001; 30:661-669.
Templin M F, Stoll D, Schrenk M, Traub P C, Vohringer C F, Joos T O. Protein microarray technology. Trends Biotechnol. 2002; 20:160-6.
Torigoe H, Maruyama A. Synergistic stabilization of nucleic acid assembly by oligo-N3′-->P5′ phosphoramidate modification and additions of comb-type cationic copolymers. J Am Chem. Soc. 2005; 127:1705-10.
Uetz, P., Giot, L., Cagney, G., Mansfield, T. A., Judson, R. S., Knight, J. R., Lockshon, D., Narayan, V., Srinivasan, M., Pochart, P., Qureshi-Emili, A., Li, Y., Godwin, B., Conover, D., Kalbfleisch, T., Vijayadamodar, G., Yang, M., Johnston, M., Fields, S., and Rothberg, J. M. A comprehensive analysis of protein-protein interactions in Saccharomyces cerevisiae. Nature 2000; 403:623-627.
Uhlén M, Björling E, Agaton C, Szigyarto C A, Amini B, Andersen E, Andersson A C, Angelidou P, Asplund A, Asplund C, Berglund L, Bergstrom K, Brumer H, Cerjan D, Ekstrom M, Elobeid A, Eriksson C, Fagerberg L, Falk R, Fall J, Forsberg M, Björklund MG, Gumbel K, Halimi A, Hallin I, Hamsten C, Hansson M, Hedhammar M, Hercules G, Kampf C. Larsson K, Lindskog M, Lodewyckx W, Lund J, Lundeberg J, Magnusson, Malm E, Nilsson P, Ödling J, Oksvold P, Olsson I, Öster E, Ottosson J, Paavilainen L, Persson A, Rimini R, Rockberg J, Runeson M, Sivertsson Å, Sköllermo A, Steen J, Stenvall M, Sterky F, Strömberg S, Sundberg M, Tegel H, Tourle S, Wahlund E, Waldén A, Wan J, Wernérus H, Westberg J, Wester K, Wrethagen U, Xu L, Hober S and Ponten F (2005) A human protein atlas for normal and cancer tissues based on antibody proteomics. Mol Cell Proteomics. 2005; 4:1920-32.
Uhlen M, Ponten F. Antibody-based Proteomics for Human Tissue Profiling. Mol Cell Proteomics. 2005; 4:384-393.
Wacker R, Schroder H, Niemeyer C M. Performance of antibody microarrays fabricated by either DNA-directed immobilization, direct spotting, or streptavidin-biotin attachment: a comparative study. Anal Biochem. 2004; 330:281-7.
Wang, Y., M. Moorhead, G. Karlin-Neumann, M. Falkowski, C. Chen, F. Siddiqui, R. W. Davis1, T. D. Willis and M. Faham Allele quantification using molecular inversion probes (MIP). Nucleic Acids Res. 2005; 33:183.
Yu A A, Savas T A, Taylor G S, Guiseppe-Elie A, Smith H I, Stellacci F. Supramolecular nanostamping: using DNA as movable type. Nano Lett. 2005; 5:1061-4.
Zengerle R, Daub M. Fast and reliable protein microarray production by a new drop-in-drop technique. Lab Chip. 2005; 5:675-81.
Zhu L, Koistinen H, Wu P, Narvanen A, Schallmeiner E, Fredriksson S, Landegren U, Stenm, U H. A sensitive proximity ligation assay for active PSA. Biol. Chem. 2006; 387:769-72.

I claim:

1. An affixed population of different binding complexes for a set of different molecular targets,
wherein each target has at least two spatially separate epitopes, and
wherein, for each target, at least one corresponding complex is provided, each complex comprising:
a nucleic acid affixed to a substratum, and having a first subsequence and a second subsequence,
a first fusion protein comprising
a first nucleic-acid-binding domain that binds to the first subsequence of the nucleic acid, and
a first epitope-binding domain that specifically binds to a first epitope of the target, and
a second fusion protein comprising
a second nucleic-acid-binding domain that binds to the second subsequence of the nucleic acid, and
a second epitope-binding domain that specifically binds to a second epitope of the target,
whereby each affixed complex in the population can bind separate epitopes of a corresponding target of the set of target molecules.

2. The population of claim 1, wherein a nucleic-acid-binding domain is selected from the group comprising Tus, Rap, mutaEcoRI, LadI^{S}, Halo-tag, Snap-tag, cutinase, DNA methylase and trwC.

3. The population of claim 1, wherein an epitope-binding domain comprises a binding portion of an antibody.

4. The population of claim 1, wherein an epitope-binding domain comprises a single-chain antibody fragment (scFv).

5. The population of claim 1, wherein an epitope-binding domain comprises a receptor protein.

6. An affixed set of molecular targets, comprising the population of claim 1, and further comprising a set of targets wherein a target is bound to a first nucleic-acid-binding domain and to a second nucleic-acid-binding domain of a complex.

7. A method for capturing a set of targets, comprising the steps of
(a) contacting a sample to the affixed population of claim 1, and
(b) providing a ligase, whereby an analyte DNA is formed.

8. The method of claim 7, further comprising the step of
(c) providing an oligonucleotide that is complementary to at least a portion of the nucleic acid of a complex.

9. The method of claim 8, wherein step (b) further comprises providing a polymerase and deoxynucleotides.

10. The method of claim 8, further comprising the step of
(d) amplifying the analyte DNA.

11. A method for detecting a set of targets, comprising
(1) performing the method of claim 7, and
(2) detecting the analyte DNA.

12. A method for quantifying a set of targets, comprising
(1) performing the method of claim 7, and
(2) quantifying the analyte DNA,
whereby the amount of the analyte DNA is related to the amount of target.
